(19) United States
(12) Patent Application Publication
(10) Pub. No.: US 2017/0178414 A1
(43) Pub. Date: Jun. 22, 2017

(54) METHOD AND APPARATUS FOR WIRELESS PARKING METER PAYMENT

(71) Applicant: FORD GLOBAL TECHNOLOGIES, LLC, Dearborn, MI (US)

(72) Inventors: Cynthia M. NEUBECKER, Westland, MI (US); Omar MAKKE, Lyon Township, MI (US)

(21) Appl. No.: 14/976,249

(22) Filed: Dec. 21, 2015

(51) Int. Cl. G07B 15/02; G06Q 20/32

(52) U.S. Cl. CPC G07B 15/02; G06Q 20/3255

(57) ABSTRACT

A system includes a processor configured to add time to a parking meter in response to wireles sly receiving a request to add additional time from a vehicle computer, including charging a payment method, included with the request, for the added time, the request being received in response to a notification sent by the processor to the vehicle computer a predetermined amount of time before time on the parking meter expires.

### TECHNICAL FIELD

The illustrative embodiments generally relate to a method and apparatus for wireless parking meter payment.

### BACKGROUND

Parking violations have long been the bane of drivers everywhere. Many times a driver will deposit a quarter in a meter, thinking that only a brief stay will be needed, and then be delayed, resulting in a ticket upwards of fifty dollars. While ticket revenues provide additional money for a city, the preferable solution is to have the drivers pay for the time used while parking.

Unfortunately, drivers often are in situations that they cannot simply leave when a meter expires. In other instances, the drivers may not even realize that a meter is going to expire, or, in order to forego the hassle of running out to the meter, the driver will risk the chance that they won't get a ticket before they return to the meter. If provided with an option to pay for the meter without having to return to the vehicle, however, it is much more likely that most drivers will simply opt for paying the meters. Cities would be incentivized to participate in such a program because all the increased revenue from constantly-filled meters would help offset losses in tickets, would result in greater citizen satisfaction, and would avoid the hassle and cost associated with collecting ticket fees as opposed to simply gathering the meter payments.

### SUMMARY

In a first illustrative embodiment, a system includes a processor configured to add time to a parking meter in response to wireles sly receiving a request to add additional time from a vehicle computer, including charging a payment method, included with the request, for the added time, the request being received in response to a notification sent by the processor to the vehicle computer a predetermined amount of time before time on the parking meter expires.

In a second illustrative embodiment, a system includes a vehicle-based processor configured to wirelessly request addition of a specified time amount to a parking meter, in response to a wireless instruction having been received from a mobile device, the instruction including the specified time amount.

In a third illustrative embodiment a computer-implemented method includes receiving a wireless notification at a vehicle computer from a parking meter that time is about to expire. The method also includes sending a first request to a mobile device requesting an amount of time to add to the parking meter and sending a second request to the parking meter to add a specified amount of time, included in an instruction received responsive to the first request.

### BRIEF DESCRIPTION OF THE DRAWINGS

FIG. 1 shows an illustrative vehicle computing system;

FIG. 2 shows an illustrative process for meter refilling;

FIG. 3 shows an illustrative process for meter control; and

FIG. 4 shows an illustrative process for remote meter interaction.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

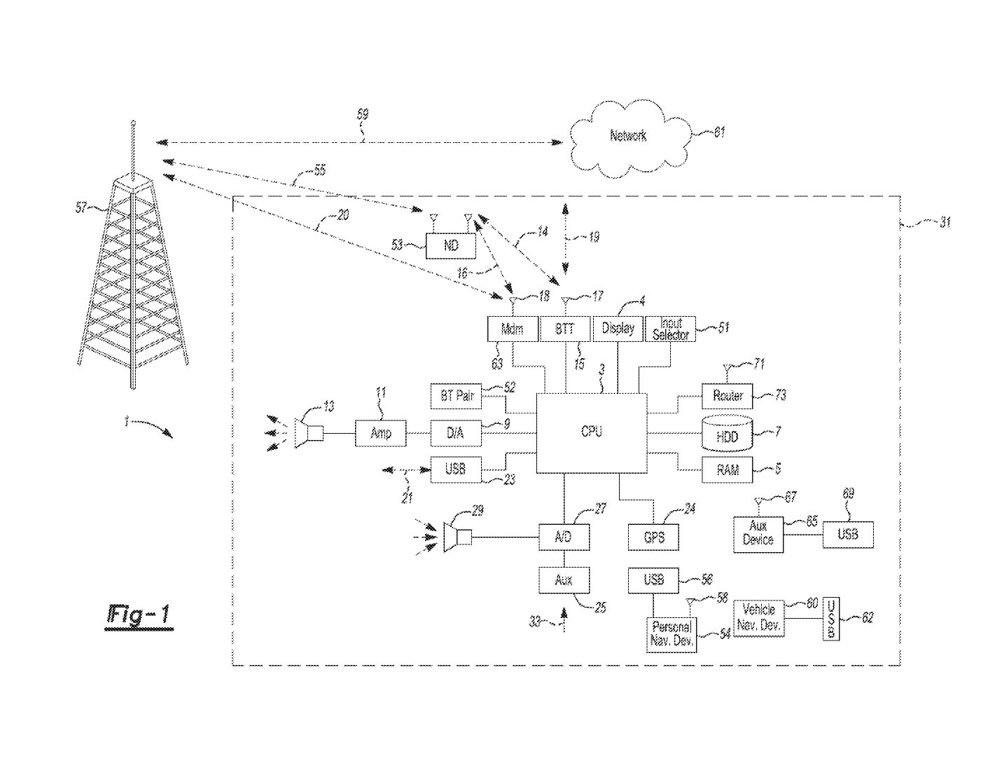

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 Mbps for stationary or walking users and 385 kbps for users in a moving vehicle. 3G standards are now being replaced by IMT-Advanced (4G) which offers 100 mbs for users in a vehicle and 1 Gbps for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

In order to provide a more convenient means of refilling parking meters, and to provide a more consistent and steady meter revenue, a wireless parking meter refill system is proposed. Utilizing wireless communication between a hub or individual meters, the proposed system allows communication between parked vehicles and parking meters for the purpose of adding time to a meter corresponding to a parked vehicle. In one example, the methodology employs dedicated short-range communication (DSRC), a wireless communication spectrum dedicated for automotive use. Using DSRC, the vehicle can instruct a meter to refill time, and provide payment options for the time, whenever time on the meter is about to expire.

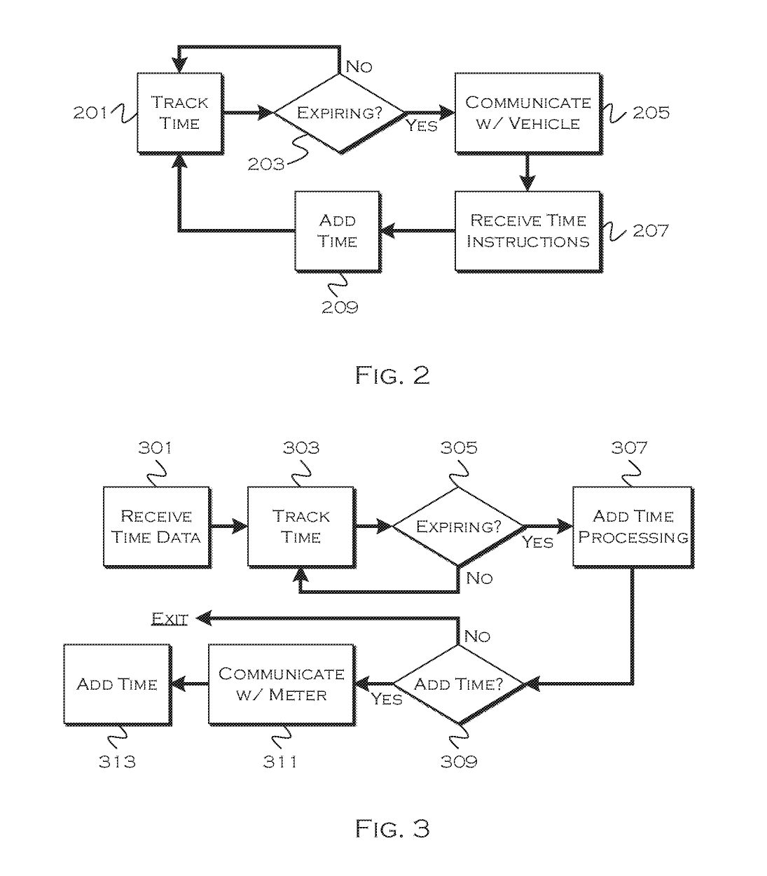

FIG. 2 shows an illustrative process for meter refilling. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, time is tracked by the metering system 201. This can be a central hub with designations corresponding to particular vehicles, or by individual meters themselves. Since each vehicle, in the embodiments, will communicate with the system for the purpose of providing payment and time increases, there will likely need to be some form of short range transceiver installed at the individual parking spaces, so that there is not a miscommunication resulting in time being added for the wrong space. This can also be addressed by, for example, having a driver input a vehicle space number into a vehicle-displayed interface when parking the vehicle, which would then correlate that particular vehicle to the particular input space number. The driver could also enter some other form of identification in a central hub, for example, such as a vehicle “username” which could be used by a central system to identify and locate a vehicle. While these and similar solutions are all within the scope of the invention, the illustrative embodiments consider a model wherein the vehicle communicates with a proximate transceiver for control of the time associated with the parking space.

Also, since the user will need to put some amount of initial time on the meter, this could be another reason to provide a vehicle-displayed interface corresponding to the metering system. In addition to allowing the user to add time without waiting in a line or dealing with an external interface in inclement weather, the in-vehicle displayed system could allow the user to verify payment methods and ensure that the appropriate vehicle is designated as corresponding to the appropriate space. In other examples, a central interface or a local, external interface can be utilized to add an initial amount of time to the meter.

When the illustrative process determines that time is about to expire 203, typically some predetermined amount of time prior to actual expiration, the process will instruct communication with the vehicle that corresponds to the space for which time is being tracked 205. The amount of time before expiration can be user defined (in a saved protocol or on a case-by-case basis), or can be defined by the metering system itself, providing, for example, sufficient time for the user to physically return to the vehicle if the automatic time addition is unsuccessful.

In this example, the process will receive instructions from the vehicle 307 if time addition is desired, which can include, for example, an amount of time to add and a method of payment for the added time. The time is then added to the meter 309 and the payment method is charged. If, for some reason, the time addition is unsuccessful (e.g., the payment method fails), the process could alert the vehicle (which could alert the user) that the attempt to add time had failed. This would allow the user to designate a new payment method or, for example, return to the vehicle to physically pay for additional time to be added.

The actual payment itself could be facilitated through a variety of manners. Credit card information could be stored on the vehicle and provided to the meter on an as-needed basis. In another example, a vehicle or user mobile device could be provided with a merchant ID, and process the card payment without transmitting the card information, so that there was less chance of the card information being “stolen” mid-transmission. A confirmation code could then be returned to the meter that demonstrates that the requested payment for the added time was successful.

In still another embodiment, a pre-paid amount of money could be “stored” digitally on the vehicle, which could be accessed by the meter. This would prevent any more than the pre-paid amount from being stolen by a malicious attempt. In still another example, a small card reader, such as the SQUARE, could be used to swipe a card on a phone when payment for time was needed.

FIG. 3 shows an illustrative process for meter control. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process executes on a vehicle computing system and tracks the time locally on the vehicle computer. This places the burden of time tracking on the vehicle computer, and ensures that errors in the metering system will not result in inadvertent time expiration. The initial time data is received by the vehicle computer 301, when, for example, the time is initially input. A signal to start the time could also be received, although out of an abundance of caution, the system may elect to start tracking as soon as the time is received. Since the worst that could occur by early tracking is the user accidentally paying for a few seconds or a minute of extra time (since a refill may occur slightly before it is actually needed), it is unlikely that users would object to the overly cautious approach.

As with the meter-tracking system shown in FIG. 2, the vehicle process in FIG. 3 tracks the time 303 until the window for time expiration is reached 305. As before, this could be a user or system defined amount of time before expiration, although it is likely some period of time prior to actual expiration, so that a ticket is not issued while the selection of and payment for additional time is being performed.

In this example, when the meter is about to expire, some form of “add time” processing occurs 307. This can include, but is not limited to: automatically adding some designated amount of time, communicating with a user to request time selection and/or payment, and any other suitable time-addition related selection and/or payment.

If time is to be added based on the add time processing 309, the process will then communicate with the meter 311 (via DSRC in this example) and instruct addition of time at the meter 313. As before, if there is an error with the time addition, the user may be notified so a new payment method can be tried or the user can physically add time to the meter. In another example, a confirmation code or notice could be provided to the user so that the user knew that the addition of time was successful. Once time is added, the countdown process can begin anew, now including the newly added amount of time to any remaining time from the previous countdown.

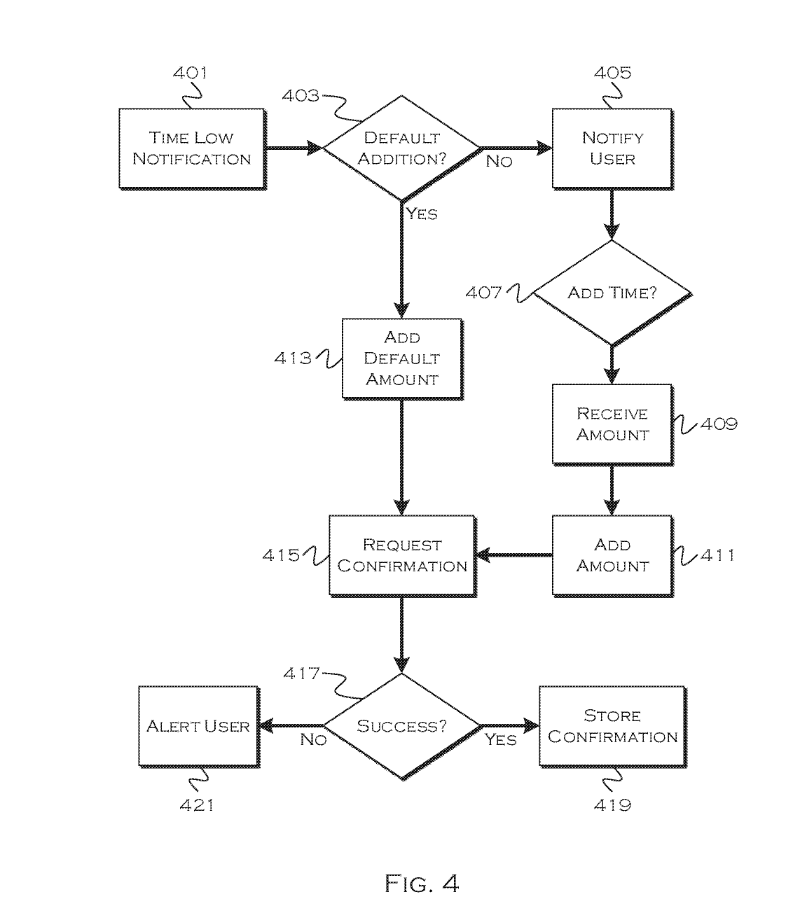

FIG. 4 shows an illustrative process for remote meter interaction. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process (running on a vehicle computer or a metering system) includes the steps of notifying a user and adding time in response to user elected time addition. Here, a time-low notification is first generated and sent 401. This could be a notification from a metering system to a vehicle, or from a vehicle to a user mobile-device. In another example, the notification is sent to the vehicle and then subsequently relayed to the user mobile device.

In some cases, there may be a default amount of time that is to be added to the metering system 403. That is, instead of having to interact with a device to specify an amount of time to be added for any given scenario, the user may elect to have, for example, fifteen minutes added automatically any time a meter is about to expire. While this may result in the user paying for up to fifteen minutes of extra time, the system can also thus ensure that a meter never expires and that a much more expensive parking ticket is never issued to the vehicle.

If automatic payment is configured, on a vehicle-based setting or mobile device-based setting, the process may add the specified amount of time 413. Payment for this time can also be processed at the time of addition. If there is no setting for automatically adding time, the process may then notify a user that the time on the meter is about to expire 405. This message can include, for example, a designation of remaining time, a total amount of time that the vehicle has been at a location (if, for example, there is a maximum amount of time that the vehicle can stay, and any other useful information). The message also gives the user (or interacts with a mobile application to give the user) an option to add time to the meter 407.

The user is given the option to add time in case, for example, the user may be low on funds or the user may be headed back to the vehicle and may not care about the minute or two which may be unmetered if arrival at the vehicle is imminent. If the user elects to add time to the meter 407, the process then prompts the user for a time amount and receives an input amount of time to be added 409. At this point, if not already specified, payment information can also be input into the mobile device. The selected amount of time is then added (or instructed to be added, depending on where the process is executing) 411 and payment for the time can be processed.

Also, in this example, a confirmation of success may be requested 415. As previously noted, the confirmation request can serve to ensure that time has been added to the meter so that a failure to process the time addition request or payment for the time does not result in a meter not being re-filled. If the confirmation results in a success 417, the process may store a notification and/or confirmation code on the vehicle or mobile device 419, as well as notifying a user that the request was successfully completed. Storage of the confirmation code and/or success message could be useful if there was an error with the meter after the time was added, and a ticket was inadvertently issued.

If the request for confirmation results in a notice that the attempt failed, the process may notify the user of the failure 421 Such notification could include an option to change a payment method (if payment failed) or change a selected amount of time (if a maximum was exceeded, for example). If the error was more general in nature (e.g., a communication error prevented time from being added or a general run-time error prevented time from being added), there may not be a selection of a new option available, but instead the user may have to return to the vehicle and manually add time if desired.

Through use of DSRC and a wireless meter refill system proposed by the illustrative embodiments, drivers can more easily refill parking meters. This increases overall driver satisfaction because the number of tickets resulting from underpaid meters is likely greatly diminished or eliminated. At the same time, this ensure that meters are always full while a vehicle is in the space, which provides a more steady and consistent revenue for a lot-managing authority.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various illustrative embodiments may be combined to form further embodiments of the invention.

What is claimed is:

1. A system comprising:
a processor configured to:
add time to a parking meter in response to wireles sly receiving a request to add additional time from a vehicle computer, including charging a payment method, included with the request, for the added time, the request being received in response to a notification sent by the processor to the vehicle computer a predetermined amount of time before time on the parking meter expires.

2. The system of claim 1, wherein the request is received over a dedicated short-range channel (DSRC).

3. The system of claim 1, wherein the predetermined amount of time is preconfigured and stored in a parking meter memory.

4. The system of claim 1, wherein the predetermined amount of time is user-defined, stored in a vehicle memory, and received by the processor when an initial amount of time is added to the parking meter.

5. The system of claim 1, wherein the processor is further configured to send a confirmation message to the vehicle computer once the time has been added.

6. The system of claim 1, wherein the processor is further configured to send an error message to the vehicle computer, if time cannot be added, the error message including a reason why time cannot be added.

7. A system comprising:
a vehicle-based processor configured to:
wireles sly request addition of a specified time amount to a parking meter, in response to a wireless instruction having been received from a mobile device, the instruction including the specified time amount.

8. The system of claim 7, wherein the wireless instruction further includes a payment method and the processor is configured to include the payment method in the request.

9. The system of claim 7, wherein the processor is configured to notify the mobile device that time is about to expire on the parking meter and request the instruction from the mobile device.

10. The system of claim 7, wherein the processor is configured to notify the mobile device that time is about to expire in response to a message received wirelessly from the parking meter.

11. The system of claim 7, wherein the processor is configured to notify the mobile device that time is about to expire in response to a determination that only a predetermined amount of time exists before the parking meter expires.

12. The system of claim 7, wherein the processor is configured to wirelessly request addition of the specified time amount using a dedicated short-range channel (DSRC).

13. The system of claim 7, wherein the processor is configured to wirelessly request addition of the specified time amount based on a determination that a vehicle memory contains an instruction to add a predetermined amount of time, to be used as the specified time amount, if the parking meter is about to expire, instead of requesting addition of the specified time in response to the wireless instruction having been received.

14. A computer-implemented method comprising:
receiving a wireless notification at a vehicle computer from a parking meter that time is about to expire;
sending a first request to a mobile device requesting an amount of time to add to the parking meter; and
sending a second request to the parking meter to add a specified amount of time, included in an instruction received responsive to the first request.

15. The method of claim 14, wherein at least the second request is sent using a dedicated short-range channel (DSRC).

16. The method of claim 14, wherein the second request includes a payment method.

17. The method of claim 16, wherein the payment method is included in the received instruction.

18. The method of claim 16, wherein the payment method is retrieved from a vehicle memory.

19. The method of claim 14, further comprising storing a confirmation that the specified amount of time was added to the parking meter, in a vehicle memory.

20. The method of claim 14, further comprising sending an error message to the mobile device, the error message including a reason why the specified amount of time was not added to the parking meter.
